(19) United States
(12) Patent Application Publication
(10) Pub. No.: US 2026/0023615 A1
(43) Pub. Date: Jan. 22, 2026

(54) Generating Workflows from Natural Language

(71) Applicant: ServiceNow, Inc., Santa Clara, CA (US)

(72) Inventors: Orlando Edson Marquez Ayala, Montreal (CA); Patrice Bechard, Montreal (CA)

(21) Appl. No.: 19/272,039

(22) Filed: Jul. 17, 2025

Related U.S. Application Data
(60) Provisional application No. 63/673,364, filed on Jul. 19, 2024.

(51) Int. Cl. G06F 9/50

(52) U.S. Cl. CPC G06F 9/5038

(57) ABSTRACT

An embodiment may involve receiving a textual description of a workflow; determining, based on the textual description and operational characteristics associated with a computing system, a workflow outline that represents respective steps of the workflow; for each of the respective steps of the workflow, identifying a respective portion of the operational characteristics based on determining that the respective portion satisfies a relevance criterion; obtaining, from a natural language model and based on the respective portions of the operational characteristics, a respective programmatic representation for each of the respective steps of the workflow; and updating the workflow outline based on the respective programmatic representations.

### CROSS-REFERENCE TO RELATED APPLICATION

This application claims priority to U.S. provisional patent application no. 63/673,364, filed July 19, 2024, which is hereby incorporated by reference in its entirety.

### BACKGROUND

Computing platforms can be used to facilitate workflows – automated or semi-automated multi-step processes that occur between combinations of computing elements, and applications. These workflows can be complex, involving numerous states, transitions therebetween, and activities. As the relevance of workflows grows, so do the number of workflows supported and their importance to the proper operation of software applications and services. Thus, workflows that contain design flaws, inefficiencies, and/or other defects can waste computing resources (e.g., processing, memory, network, and/or power capacity). For example, poorly designed or improperly used workflows can include unnecessary and/or redundant states with unneeded processing steps, as well as inefficient handling of transitions or other events.

### SUMMARY

Various implementations disclosed herein include techniques for generating programmatic definitions of workflows from natural language descriptions thereof. These definitions may specify a trigger that causes the workflow to initiate execution, as well as a set of one or more steps performed by the workflow. To reduce computing resources used to generate the workflow, the workflow may be generated in two phases. First, a workflow outline is generated. The workflow outline may include an annotated specification of the trigger as well as specification of the steps. Then, for each of the steps in the workflow outline, a programmatic definition of a corresponding action is generated. These programmatic definitions may reference specific database tables and fields, computing system interfaces, and/or applications executable on a computing system, and may include program logic or snippets of code. A natural language model may be used to generate the workflow outline and/or the programmatic definitions of the steps. This approach to generating workflows increases their correctness and efficiency, resulting in less computing resource wastage when the workflows are executed.

A system of one or more computers or computing systems can be configured to perform particular operations or actions by virtue of having software, firmware, hardware, or a combination thereof installed that in operation causes or cause the computer(s) or systems(s) to perform the actions. One or more computer programs can be configured to perform particular operations or actions by virtue of including instructions that, when executed by data processing apparatus, cause the apparatus to perform the actions.

One general aspect involves a method. The method includes receiving a textual description of a workflow. The method also includes determining, based on the textual description and operational characteristics associated with a computing system, a workflow outline that represents respective steps of the workflow. The method also includes, for each of the respective steps of the workflow, identifying a respective portion of the operational characteristics based on determining that the respective portion satisfies a relevance criterion. The method also includes obtaining, from a natural language model and based on the respective portions of the operational characteristics, a respective programmatic representation for each of the respective steps of the workflow. The method also includes updating the workflow outline based on the respective programmatic representations.

Other embodiments include corresponding computer system(s), apparatus(es), and computer program(s) recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts another communication environment involving a remote network management architecture, in accordance with example embodiments.

FIG. 5 depicts a workflow generation and execution environment, in accordance with example embodiments.

FIG. 6 depicts a workflow, in accordance with example embodiments.

FIG. 7 depicts a tree-like visualization of a workflow with input drawn from a database, in accordance with example embodiments.

FIG. 8A depicts generating specifications of workflows, in accordance with example embodiments.

FIG. 8B depicts identifying database tables and fields relevant to a step of a workflow, in accordance with example embodiments.

FIGS. 9A,9B and 9C depict a phased approach for generating a workflow, in accordance with example embodiments.

FIG. 10 depicts further generation of a workflow outline based on metadata, in accordance with example embodiments.

FIG. 11 is a flow chart, in accordance with example embodiments.

### DETAILED DESCRIPTION

Example methods, devices, and systems are described herein. The words “example” and “exemplary” are used to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. The aspects of the present disclosure can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

Herein, the terms “rows”, “entries”, and “records” in the context of a database may be used synonymously to refer to individual data instances or tuples that each represent a single occurrence or item within the dataset defined by a table schema employed by the database. For example, each value in a row, entry, or record may correspond to a specific attribute or column of a table.

Herein, a “workflow” is defined as a configurable sequence of operations, tasks, or actions that are performed automatically or semi-automatically in response to one or more triggering events. Each step in a workflow may include conditions, logic branches, and/or dependencies. The workflow may facilitate the execution of a defined process involving data transformation, task coordination, and/or inter-system communication.

User interaction with GUI elements, such as buttons, menus, tabs, sliders, checkboxes, toggles, etc., may be referred to herein as “selection”, “activation”, or “actuation” thereof. These terms may be used regardless of whether the GUI elements are interacted with by way of keyboard, pointing device, touchscreen, or another mechanism.

### I. Example Technical Improvements

These embodiments provide a technical solution to a technical problem. One technical problem being solved is efficient generation of accurate workflows. In practice, this is problematic because development of workflows is a time-intensive and compute-intensive process, and because inaccurate and/or inefficient workflows waste computing resources (e.g., processing, memory, network, and/or power capacity).

In other techniques, workflows were developed in an ad hoc manner, often relying on subjective decisions and experiences of individual designers. This leads to wildly varying outcomes from instance to instance, as well as lower efficiency for workflows. Thus, other techniques did little if anything to address accuracy or efficiency of workflows.

The embodiments herein overcome these limitations by employing a two-phase process for generation of workflows based on queries to a natural language model. In this manner, workflow accuracy and efficiency can be accomplished in a more robust fashion. This results in several advantages. For example, workflows can be generated first as a workflow outline of steps, and then with each step being specified in turn. Doing so is a more efficient use of a natural language model than generating a workflow all at once. Also, the natural language model can populate the generated workflows with metadata or other types of information relating to operational characteristics of the computing platform on which the workflows are to be operated. This also improves the efficiency of workflow generation and workflow operation.

Thus, the generated workflows can include platform-specific adaptations, such as scheduling parameters, resource limits, error handling, and/or data retention policies tailored to the characteristics of the target environment. Additionally, the natural language model can identify and eliminate redundant or unreachable states or transitions during workflow generation, thereby reducing unnecessary processing during workflow execution.

Other technical improvements may also flow from these embodiments, and other technical problems may be solved. Thus, this statement of technical improvements is not limiting and instead constitutes examples of advantages that can be realized from the embodiments.

### II. Introduction

A computing environment in a large enterprise may involve numerous interrelated operations, some of which are common across different organizations. To support commonly implemented operations, enterprises may employ off-the-shelf software applications. However, each enterprise may also require software applications to support specific internal processes or workflows. These unique operations may necessitate the development of custom software tailored to enterprise-specific requirements.

An enterprise may operate dozens or hundreds of such custom software applications. In some instances, these applications may be developed independently by different departments or operational units. Custom applications may range from spreadsheet-based tools to purpose-built software and database systems. However, the proliferation of such siloed applications can complicate system integration and data interoperability. Fragmented software ecosystems can hinder the ability to coordinate workflows, synchronize data, and support consistent process execution across the enterprise, due to the dispersion of logic and data across heterogeneous and incompatible systems.

To address this challenge, enterprises may utilize a remotely-hosted application development and execution platform that manages lower-level system complexity and provides infrastructure for building configurable applications. One example of such a platform is an Application Platform as a Service (aPaaS), which can enable the automated definition and execution of application logic and workflows. An aPaaS system may be hosted external to the enterprise network but can securely interface with enterprise systems, databases, and external services using authenticated and encrypted communications.

In some embodiments, the aPaaS system may be implemented using a database-driven architecture in which application logic, user interface definitions, workflow sequences, and access control rules are represented as records in one or more centralized databases. For instance, a metadata-based graphical user interface (GUI) framework may define GUI elements – such as forms, menus, tables, and workflow components – via configuration records stored in the database. These metadata records may specify characteristics such as field layout, data bindings, conditional display rules, user access privileges, and component behaviors. A rendering engine or interpretation layer may read and process the metadata at runtime to dynamically generate GUI components. This approach allows the system to support configurable user interfaces and application logic without requiring direct modification of core source code.

The aPaaS system may further provide standardized GUI components, such as reusable widgets or web components, to facilitate consistency across applications. The system may support applications structured according to a model-view-controller (MVC) architecture, in which application functionality is divided into a model (data layer), a view (presentation layer), and a controller (logic layer). This separation of concerns may support modularity, concurrent development, and reuse of application components. In some embodiments, applications may expose create, read, update, and delete (CRUD) operations and may be delivered via web-based front ends. Alternative application structures, such as those based on unidirectional data flow, may also be supported.

Such GUIs within the aPaaS system may be defined, rendered, or delivered in multiple data formats depending on the system architecture and client device requirements. For example, a server device may construct a GUI representation using a combination of HyperText Markup Language (HTML) and JavaScript code, which may include client-side and/or server-side executable instructions. The server may transmit this GUI representation to a client device for rendering according to local rendering logic or device-specific presentation settings. In other embodiments, the GUI may be provided as an intermediate representation (e.g., Java bytecode) that a client can interpret to generate graphical output. Additional encodings may include structured metadata (e.g., in JavaScript Object Notation (JSON) or eXtensible Markup Language (XML)) describing components, behaviors, or layout of the interface.

The aPaaS system may also include a set of predefined features that can be incorporated into applications built on the platform. These may include components for search functionality, email generation, templating systems, workflow design tools, data visualization or reporting modules, event-driven scripting, support for mobile device rendering, and/or GUI customization capabilities.

Other features, components, or variations of an aPaaS system may be used. The examples provided herein are illustrative and not intended to be limiting.

### III. Example Computing Devices and Cloud-Based Computing Environments

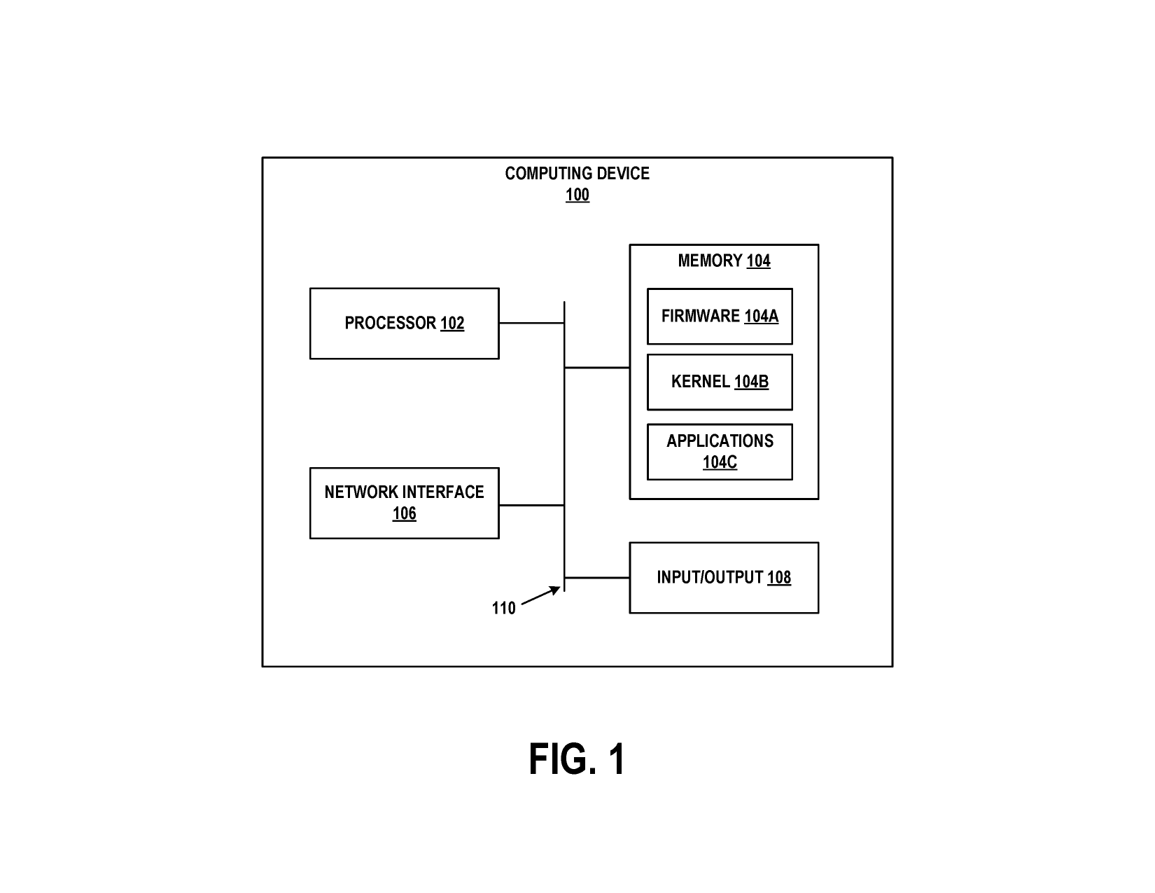

FIG. 1 is a simplified block diagram of an example computing device 100, illustrating some of the components that could be included in a computing device configured to operate in accordance with the embodiments herein. Computing device 100 may be a client device (e.g., a device actively operated by a user), a server device (e.g., a device that provides computational services to client devices), or some other type of computational platform. Some server devices may operate as client devices from time to time to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, video screens, and so on).

Processor 102 may be one or more of any type of computer processing element, such as a central processing unit (CPU), graphical processing unit (GPU), digital signal processor (DSP), network processor, encryption processor, and/or other integrated circuit or controller capable of performing processor operations. In some embodiments, processor 102 may comprise one or more single-core or multi-core processors, with each core representing an independent processing unit. Processor 102 may also include register memory for temporarily storing instructions and related data, and cache memory for temporarily storing recently used instructions and data.

GPUs may include specialized circuitry designed to perform rapid mathematical calculations for rendering graphics, processing large datasets, and supporting machine learning. A GPU may include a large number of small processing cores that operate in parallel, facilitating the decomposition of tasks into smaller units that can be processed concurrently. This parallelism may allow GPUs to outperform traditional CPUs for certain classes of computational tasks (though CPUs may also support forms of parallelism at the core or instruction level).

Memory 104 may include any form of computer-usable memory, including but not limited to random access memory (RAM), read-only memory (ROM), and non-volatile memory such as hard disk drives, solid state drives, compact discs (CDs), digital video discs (DVDs), and/or magnetic tape storage. Memory 104 may therefore include both volatile and non-volatile memory components. Any non-volatile memory may also be referred to as persistent storage. Memory 104 may store program instructions and/or data on which the program instructions operate. For example, memory 104 may store instructions on a non-transitory, computer-readable medium, where the instructions are executable by processor 102 to perform any of the methods or operations described herein.

As shown in FIG. 1, memory 104 may include firmware 104A, kernel 104B, and/or applications 104C. Firmware 104A may comprise program code used to initialize computing device 100. Kernel 104B may include an operating system with modules for memory management, process scheduling, input/output handling, and device communication. Kernel 104B may also include device drivers that enable the operating system to interface with hardware components. Applications 104C may include user-space software such as web browsers, email clients, web servers, and/or software libraries.

Network interface 106 may include one or more wireline interfaces, such as Ethernet (e.g., Gigabit Ethernet, 10 Gigabit Ethernet, Ethernet over fiber). Network interface 106 may also support one or more non-Ethernet communication media, including wireless protocols such as Wi-Fi (e.g., IEEE 802.11), Bluetooth (IEEE 802.15.1), cellular (e.g., 3G, 4G LTE, 5G NR), and Zigbee (IEEE 802.15.4). Other supported interfaces may include Near Field Communication (NFC), infrared (IrDA), Universal Serial Bus (USB)-based network adapters, and/or High-Definition Multimedia Interface (HDMI) connectors. Additional or alternative interfaces may be used.

Input/output unit 108 may facilitate interaction between computing device 100 and peripheral devices or users. The input/output unit may include input devices such as keyboards, mice, and touchscreens, and output devices such as monitors, printers, or light-emitting diodes (LEDs). Computing device 100 may communicate with these types of devices using a port configured to support USB or HDMI for example.

In some embodiments, one or more computing devices such as computing device 100 may be deployed off-premises. The physical location, network configuration, and/or internal topology of these devices may not be apparent to client devices. Accordingly, such devices may be implemented as cloud-based computing platforms residing in one or more data center environments.

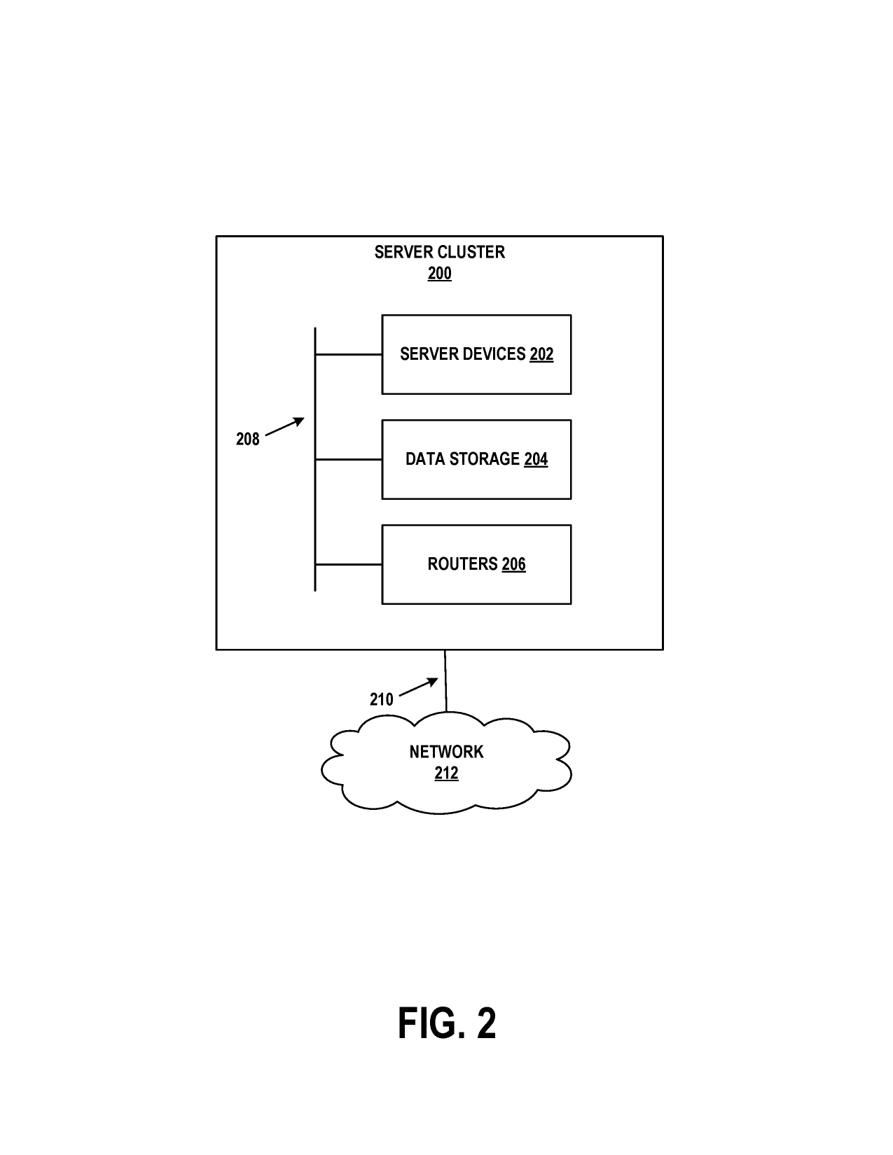

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, instances data storage 204, and routers 206 in server cluster 200 may depend on the computing task(s) and/or applications assigned to server cluster 200.

For example, server devices 202 may be configured to perform various computing tasks of computing device 100. Thus, computing tasks can be distributed among one or more of server devices 202. To the extent that these computing tasks are performed in parallel, such a distribution of tasks may reduce the total time to complete these tasks and return a result. For purposes of simplicity, both server cluster 200 and individual server devices 202 may be referred to as a “server device.” This nomenclature should be interpreted to encompass configurations involving one or more distinct server devices, data storage systems, and cluster-level routing components, and should be interpreted to encompass any such configurations.

Data storage 204 may include data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to mitigate data loss due to drive failures or other system faults. Other types of memory devices, aside from drives, may be used.

Routers 206 may include networking equipment configured to provide internal and external communications for server cluster 200. For example, routers 206 may include one or more network-layer switching or routing components (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be implemented as monolithic systems or distributed across multiple physical or virtualized storage resources.

Server devices 202 may be configured to transmit data to and receive data from data storage 204. This transmission and retrieval may take the form of SQL queries or other types of database queries, and the output of such queries, respectively. Additional content, such as text, images, video, and/or audio may be included as well. Furthermore, server devices 202 may organize the received data into web pages or web application representations. Such a representation may take the form of a markup language, such as HTML, XML, JSON, or some other standardized or proprietary format. Moreover, server devices 202 may have the capability of executing various types of computerized scripting languages, including but not limited to Perl, Python, PHP Hypertext Preprocessor (PHP), Active Server Pages (ASP), JavaScript, and so on. Computer program code written in these languages may facilitate the provision of web pages to client devices, as well as client device interaction with the web pages. Alternatively or additionally, Java may be used to facilitate the generation of web pages and/or to provide web application functionality with dynamic content handling.

### IV. Example Remote Network Management Architecture

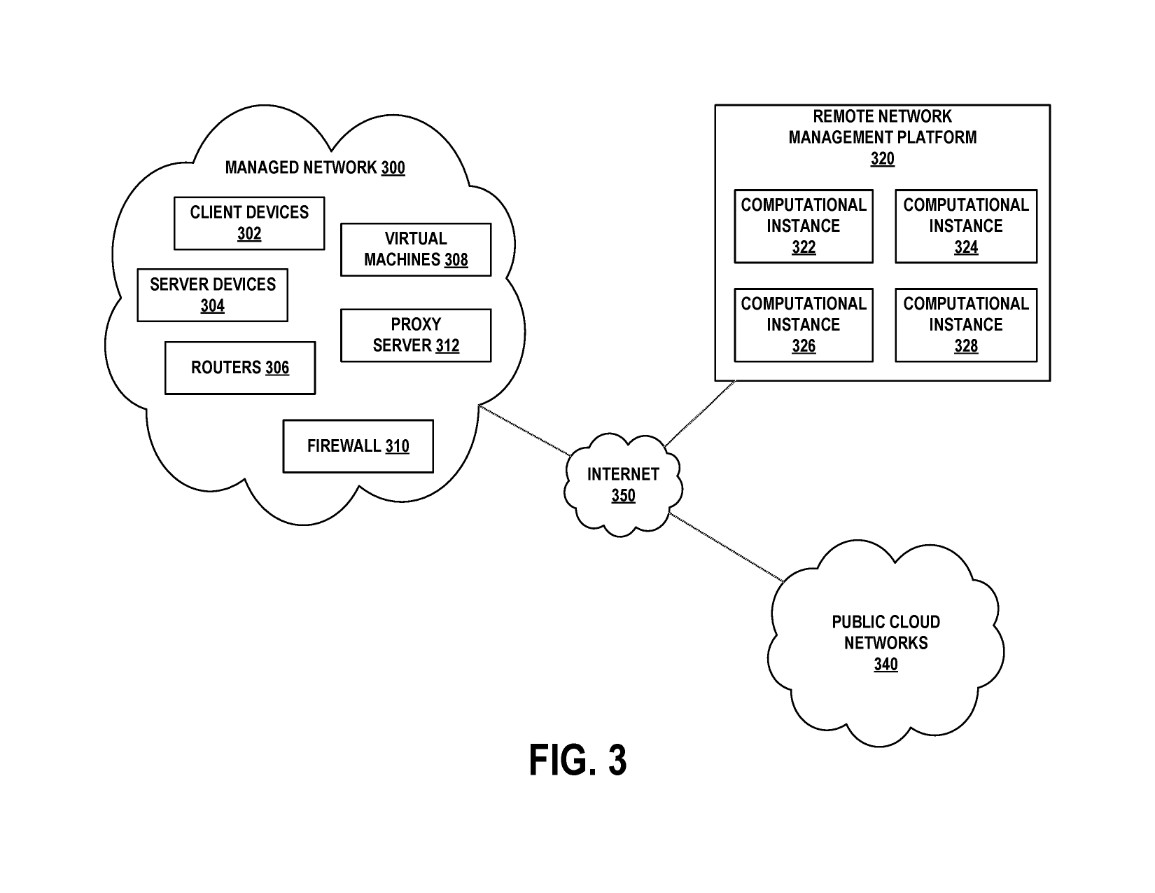

FIG. 3 depicts a remote network management architecture, in accordance with example embodiments. This architecture includes three main components – managed network 300, remote network management platform 320, and public cloud networks 340 – all connected by way of Internet 350.

### A. Managed Networks

Managed network 300 may be, for example, an enterprise network used by an entity for computing and communications tasks, as well as for the storage of data. Thus, managed network 300 may include client devices 302, server devices 304, routers 306, virtual machines 308, firewall 310, and/or proxy server 312. Client devices 302 may be embodied by computing device 100, server devices 304 may be embodied by computing device 100 or server cluster 200, and routers 306 may be any type of router, switch, or gateway.

Virtual machines 308 may be operated by way of one or more of computing device 100 or server cluster 200. In general, a virtual machine is an emulation of a computing system that replicates the functionality (e.g., processor, memory, and communication resources) of a physical computer. One physical computing system, such as server cluster 200, may support hundreds or thousands of individual virtual machines. In some embodiments, virtual machines 308 may be managed by a centralized server device or application that facilitates allocation of physical computing resources to individual virtual machines, as well as performance and error reporting. Managed network 300 may employ virtual machines in order to allocate computing resources in an efficient, as needed fashion.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other network security. In some embodiments not shown in FIG. 3, managed network 300 may include one or more virtual private network (VPN) gateways used to communicate with remote network management platform 320.

Managed network 300 may also include one or more of proxy server 312. In some embodiments, proxy server 312 may be a server application that facilitates communication and movement of data between managed network 300, remote network management platform 320, and/or public cloud networks 340. Proxy server 312 may be able to establish and maintain secure communication sessions with one or more computational instances of remote network management platform 320. Through such sessions, remote network management platform 320 may be able to discover and manage aspects of the architecture and configuration of managed network 300 and its components.

Possibly with the assistance of proxy server 312, remote network management platform 320 may also be able to discover and manage aspects of public cloud networks 340 that are used by managed network 300. While not shown in FIG. 3, one or more of proxy server 312 may be deployed within any of public cloud networks 340 in order to facilitate this functionality.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy server 312 behind firewall 310 (e.g., within managed network 300 and protected by firewall 310), proxy server 312 may be able to initiate these communication sessions through firewall 310. Thus, firewall 310 may not require specific configuration to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and tens or hundreds of thousands of devices. Thus, the architecture depicted in FIG. 3 is capable of scaling in accordance with deployment size and complexity.

Furthermore, depending on the size, architecture, and connectivity of managed network 300, a varying number of proxy server 312 may be deployed therein. For example, each one of proxy server 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using web-based technologies. Thus, a user can securely access remote network management platform 320 from, for example, client devices 302, or potentially from a client device outside of managed network 300. By way of the web-based portals, users may design, test, and deploy applications, participate in workflows, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly functioning aPaaS system) available to a particular enterprise. In some cases, a single enterprise may use multiple computational instances.

For example, managed network 300 may use computational instances 322, 324, and 326. Computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more database tables or rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

In some embodiments, remote network management platform 320 may include one or more central instances, controlled by the entity that operates this platform. Like a computational instance, a central instance may include application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces to obtain this data.

As an example of such communication, a computational instance of remote network management platform 320 may support both inbound and outbound representational state transfer (REST) interfaces to enable integration with external systems and services. Inbound REST interfaces allow external systems to initiate communication with the computational instance by sending HTTP requests to specified endpoints exposed by the computational instance. These inbound interfaces can be used, for example, to create or update records, trigger workflows, or retrieve data from platform databases. Conversely, outbound REST interfaces permit the computational instance to initiate communication with external systems by issuing HTTP requests to remote APIs, thereby allowing the computational instance to push updates, retrieve external data, or invoke external services as part of workflows or automation routines.

To support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. However, full virtualization of server cluster 200 may not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include third-party platforms such as Amazon AWS Cloud, Microsoft Azure Cloud (Azure), and Google Cloud Platform (GCP). Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the operator of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. To establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area network.

### V. Example Discovery

For remote network management platform 320 to administer the devices, applications, and services of managed network 300, remote network management platform 320 may first determine the devices present in managed network 300, along with the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining these configuration items and relationships therebetween within managed network 300 is referred to as “discovery”, and may be facilitated at least in part by proxy server 312. To that point, proxy server 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure similar to object-oriented software modules. For instance, a configuration item class of “server” may inherit all attributes from a configuration item class of “hardware” and include further server-specific attributes. Likewise, a configuration item class of “Linux server” may inherit all attributes from the configuration item class of “server” and include additional Linux-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

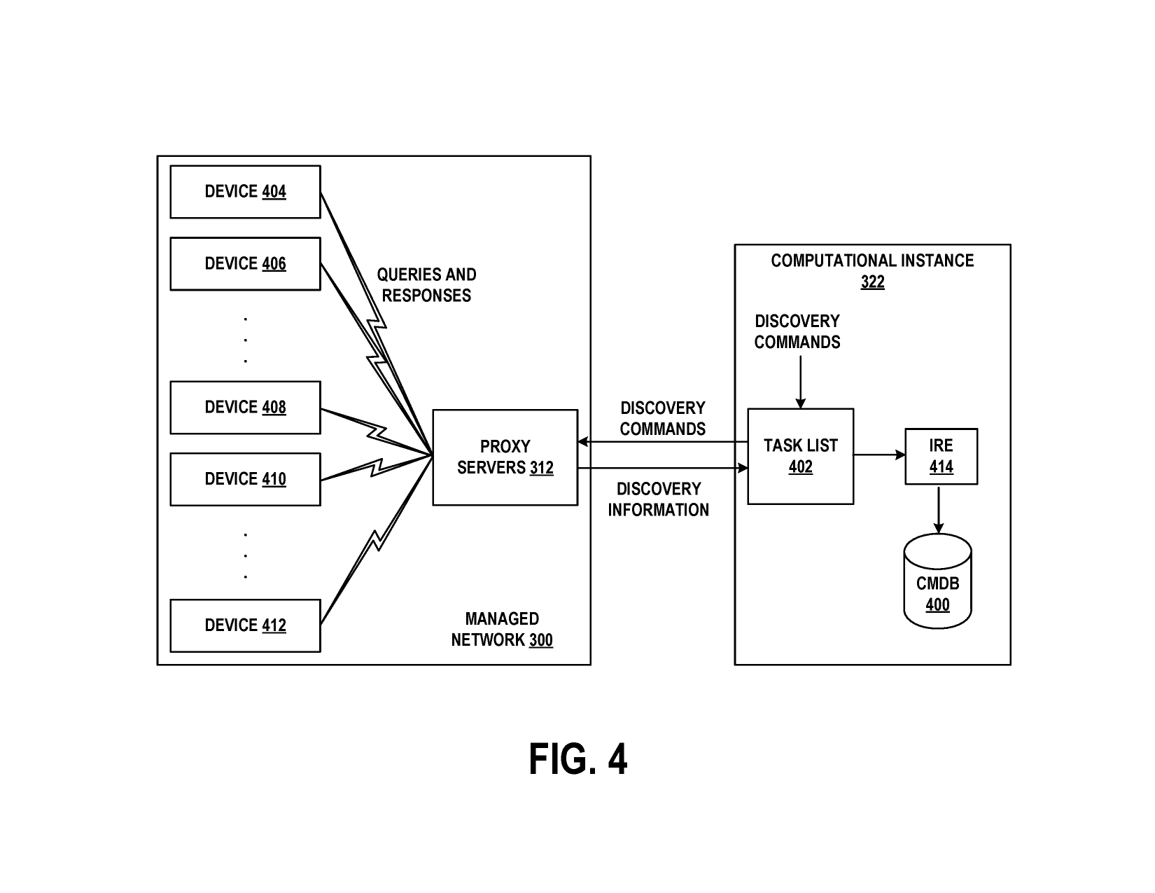

FIG. 4 provides a logical depiction of how configuration items and relationships can be discovered, as well as how information related thereto can be stored. For simplicity, public cloud networks 340 and Internet 350 are not shown.

In FIG. 4, CMDB 400, task list 402, and identification and reconciliation engine (IRE) 414 are disposed and/or operate within computational instance 322. Task list 402 represents a connection point between computational instance 322 and proxy server 312. Task list 402 may be referred to as a queue, or more particularly as an external communication channel (ECC) queue. Task list 402 may represent not only the queue itself but also any associated processing, such as adding, removing, and/or manipulating information in the queue.

As discovery takes place, computational instance 322 may store discovery tasks (jobs) that proxy server 312 is to perform in task list 402, until proxy server 312 requests these tasks in batches of one or more. Placing the tasks in task list 402 may trigger or otherwise cause proxy server 312 to begin discovery operations. For example, proxy server 312 may poll task list 402 periodically or from time to time, or may be notified of discovery commands in task list 402 in some other fashion. Alternatively or additionally, discovery may be manually triggered or automatically triggered based on various events (e.g., discovery may automatically begin once per day at a particular time).

Regardless, computational instance 322 may transmit these discovery commands to proxy server 312 upon request. For example, proxy server 312 may repeatedly query task list 402, obtain the next task therein, and perform this task until task list 402 is empty or another stopping condition has been reached. In response to receiving a discovery command, proxy server 312 may query various devices, components, applications, and/or services in managed network 300 (represented for simplicity in FIG. 4 by devices 404, 406, 408, 410, and 412). These devices, components, applications, and/or services may provide responses relating to their configuration, operation, and/or status to proxy server 312. In turn, proxy server 312 may then provide this discovered information to task list 402. Thus, task list 402 may include an outgoing queue for holding discovery commands until requested by proxy server 312 as well as an incoming queue for holding the discovery information until it is read.

IRE 414 may be a software module that removes discovery information from task list 402 and formulates this discovery information into configuration items (e.g., representing devices, components, applications, and/or services discovered on managed network 300) as well as relationships therebetween. Then, IRE 414 may provide these configuration items and relationships to CMDB 400 for storage therein. The operation of IRE 414 is described in more detail below.

In this fashion, configuration items stored in CMDB 400 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items and may include dependency types or attributes to specify the nature of the relationship.

For discovery to take place in the manner described above, proxy server 312, CMDB 400, and/or one or more credential stores may be configured with credentials for the devices to be discovered. Credentials may include any type of information needed to access the devices. These may include userid / password pairs, certificates, tokens, and so on. In some embodiments, these credentials may be stored in encrypted fields of CMDB 400. Proxy server 312 may contain the decryption key for the credentials so that proxy server 312 can use these credentials to log on to or otherwise access devices being discovered without requiring human intervention.

There are two general types of discovery – horizontal and vertical (top-down). Each type is described below.

### A. Horizontal Discovery

Horizontal discovery is used to scan managed network 300, find devices, components, and/or applications, and then populate CMDB 400 with configuration items representing these devices, components, and/or applications. Horizontal discovery also creates relationships between the configuration items. For instance, this could be a “runs on” relationship between a configuration item representing a software application and a configuration item representing a server device on which it executes.

There are two versions of horizontal discovery. One relies on probes and sensors, while the other also employs patterns. Probes and sensors may be scripts (e.g., written in JavaScript) that collect and process discovery information on a device and then update CMDB 400 accordingly. More specifically, probes explore or investigate devices on managed network 300, and sensors parse the discovery information returned from the probes and generate structured outputs to facilitate CMDB updates.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery based on device-specific logic or protocol handling.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy server 312, as well as between proxy server 312 and task list 402. Some phases may involve storing partial or preliminary configuration items in CMDB 400, which may be updated in a later phase as additional information becomes available.

In the scanning phase, proxy server 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a Windows operating system. Similarly, if TCP port 22 is open, then the device is likely executing a Unix operating system, such as Linux. If UDP port 161 is open, then the device may be able to be further identified through the Simple Network Management Protocol (SNMP). Other possibilities exist. These heuristics guide the next phases of discovery but may not definitively identify platforms or applications.

In the classification phase, proxy server 312 may further investigate each discovered device using probes tailored to the probable platform. The probes used may depend on the ports or responses detected in the previous phase. An appropriate set of tasks may be placed in task list 402 for proxy server 312 to carry out. These tasks may result in proxy server 312 collecting metadata using configured credentials or open protocols. Based on this information, the operating system may be determined. This classification information may be stored as one or more configuration items in CMDB 400.

In the identification phase, proxy server 312 may determine specific details about a classified device. The probes or patterns may vary based on the operating system or device family identified. These tasks may result in proxy server 312 reading information from the device, such as basic input/output system (BIOS) information, serial numbers, network interface information, media access control addresses assigned to these network interfaces, IP addresses used by the device, and other device attributes. This identification information may be stored as one or more configuration items in CMDB 400 along with any relevant relationships therebetween. Doing so may involve passing the identification information through IRE 414 to avoid generation of duplicate configuration items, for purposes of disambiguation, and/or to determine the table(s) of CMDB 400 in which the discovery information should be written.

In the exploration phase, proxy server 312 may obtain further details regarding the operational state and configuration of a classified device. Probes used during this phase are typically selected based on information gathered during the classification and/or identification phases. Tasks are generated and placed in task list 402 for proxy server 312 to execute. These tasks may include collecting additional data from the device, such as processor details, memory configuration, currently running processes, installed applications, and other operational characteristics. The data discovered during exploration may then be stored as configuration items and associated relationships in CMDB 400.

Horizontal discovery of network devices, such as switches and routers, may utilize Simple Network Management Protocol (SNMP). Through SNMP, discovery tasks may gather network-specific details such as additional subnet information known to routers, operational states of network interfaces (e.g., active or inactive status, packet queue length, or packet drop statistics), and associated configuration data. Newly identified subnet IP addresses can then serve as targets for subsequent discovery operations, enabling discovery to proceed iteratively or recursively to comprehensively map the managed network.

Patterns may be specifically employed during the identification and exploration phases. In pattern-based discovery, scanning and classification phases occur similarly to how they do when using probes and sensors. Once classification is completed, a pattern probe is selected for use during the identification phase, and the designated pattern is executed. Patterns utilize a specialized scripting language designed for discovery automation and typically involve structured sequences of discovery tasks tailored to specific device types or software components.

Patterns support various specialized discovery features enabled by their scripting language. For example, patterns simplify the process of discovering and recording detailed configurations for devices, components, or applications hosted in public cloud networks, and improve efficiency for configuration file tracking. Additionally, patterns are more easily customized by users than probes and sensors. Since patterns target specific device classes or applications, they typically complete discovery tasks more efficiently.

Once horizontal discovery is complete, CMDB 400 stores configuration item representations for each discovered device, component, and/or application within managed network 300. These stored configuration items may include details such as operating system version, hardware configuration, network configuration details for client devices, server devices, and routers, as well as detailed information regarding installed applications. The configuration data collected by discovery may be accessed via user interfaces or programming interfaces (APIs), allowing users to review device configurations and operational states.

Furthermore, CMDB 400 may store records representing relationships between configuration items. For example, a server device may include various hardware components (e.g., processors, memory modules, network interfaces, storage devices, and file systems) and software applications installed or running on it. Relationships such as “contained by” for hardware components or “runs on” for software applications can be recorded in CMDB 400 to clearly represent these connections.

More generally, relationships between software configuration items and hardware configuration items can include various types, such as “is hosted on,” “runs on,” or “depends on.” For instance, a database application running on a server device may have an “is hosted on” relationship with that device, indicating that the database is hosted by the server. Conversely, the server device may maintain a reciprocal relationship of “used by” with the database application, signifying its use by the application. These relationships may be established automatically through the discovery processes described previously, or configured manually by users.

In this manner, remote network management platform 320 can accurately identify and maintain an inventory of hardware and software assets present within managed network 300.

### B. Vertical Discovery

Vertical discovery identifies and maps configuration items that collectively constitute a particular service, such as a web-based service. For instance, vertical discovery may map relationships between a web-server application, a Linux-based server, and a database application that stores data utilized by the web service. Typically, horizontal discovery is first executed to identify configuration items and their basic relationships; subsequently, vertical discovery is performed to more explicitly determine the relationships between configuration items within specific services.

Vertical discovery may employ patterns specifically programmed to identify particular combinations of hardware and software components representing known service deployments. Additionally or alternatively, vertical discovery may utilize network traffic analysis, examining communications between devices to infer relationships. In some implementations, parameters defining a service may be manually configured to enhance or facilitate vertical discovery.

Generally, vertical discovery aims to identify explicit relationships among devices, software applications, and other components that define the architecture of a service. Such relationships can often be inferred from device or application configuration files. For example, a web server application’s configuration file might reference the IP address and port of a corresponding database, from which a relationship can be inferred. Similarly, vertical discovery can analyze network traffic between devices – for instance, significant HTTP traffic (e.g., TCP port 80 or 8080) exchanged between a load balancer and a web server device may indicate a defined relationship between these components.

Relationships identified through vertical discovery may include various types. As one illustrative example, an email service might comprise an email-server software configuration item and a database software configuration item, each hosted on separate hardware devices. The email service configuration item may have a “depends on” relationship with these software configuration items, while the software configuration items reciprocally maintain a “used by” relationship with the email service. Relationships like these often cannot be comprehensively identified by horizontal discovery alone.

### VI. Example Platform Applications

As noted, remote network management platform 320 may support a number of applications and services, each of which may use or involve information from CMDB 400 and/or other databases as needed. Some of these applications and services may include task-based applications, workflows, user interface building tools, and agent interfaces, just to name a few. Other applications and services not explicitly discussed herein may benefit from the disclosed embodiments.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation / generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

Task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code / no-code approach to designing intuitive graphical user interfaces, enabling administrators and developers to build user interface components without extensive coding knowledge.

Notably, low-code / no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop facility that simplifies the process of creating user interfaces. Users can add and arrange user interface components such as fields, buttons, containers, tables, and images onto a canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial intelligence powered conversational interfaces designed to interact with users and provide automated assistance. Virtual agents can be integrated into various interfaces and applications, such as web portals, chat interfaces, and messaging platforms to offer self-service options and enhance the user experience.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user’s query or if the user requests human assistance, the conversation can be handed off to a live agent for further support and resolution. Such a handoff may involve providing, to the live agent, the context (and possibly some or all of the content) of the conversation between the user and the virtual agent.

### VII. Natural Language Models

Natural language models are machine learning systems trained to understand, generate, and/or predict human language by learning patterns from large datasets of text and possibly other sources. These models can perform tasks like translation, summarization, question answering, and/or conversation. A large language model (LLM) is an advanced natural language model, configured to understand, interpret, generate, and respond to human language in a manner that is both contextually relevant and syntactically coherent, allowing even colloquial conversation between a human user and the model.

The underlying structure of an LLM is typically based on a neural network architecture, more specifically, a variant of the transformer model. Transformers are notable for their ability to process sequential data, such as text, with high efficiency. LLM operation involves passing data through layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM’s output and expected output.

An aspect of an LLM’s functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model’s ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

### A. Multimodal LLMs

Some LLMs are multimodal in that they can receive prompts in formats other than just text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model, that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### B. Retrieval-Augmented Generation

Retrieval-augmented generation (RAG) refers to a technique wherein an LLM enhances its generated responses by first retrieving relevant information from external or supplemental knowledge sources. In operation, upon receiving a natural language prompt or query, the RAG-enabled LLM initially employs a retrieval mechanism – such as semantic search or embedding-based similarity matching – to identify and fetch relevant contextual information from an indexed external database or knowledge store. The retrieved content is then provided to the LLM alongside the original prompt, enabling the model to generate a contextually enriched response informed by both its internal linguistic capabilities and the external knowledge.

This retrieval operation typically involves embedding-based search, where vector embeddings of the input query are compared against embeddings representing stored external content. Matching is usually performed via nearest-neighbor or approximate nearest-neighbor algorithms, allowing identification of the most relevant documents or passages. Subsequently, the selected external content may be combined with the given prompt to form an augmented input sequence, which the LLM processes using its attention mechanisms and learned patterns. As a result, the generated response can more accurately and coherently address queries requiring specialized, up-to-date, or detailed domain-specific information not present within the LLM’s training corpus.

### C. LLM Reasoning

Some LLMs can employ a form of reasoning by transforming user-provided natural language input into a structured internal representation, which is then used to generate a response based on learned statistical associations and contextual dependencies. For complex queries requiring multi-step inference (e.g., mathematical problems, logical deductions, or temporal event analysis), the LLM can decompose the problem into intermediate steps by generating latent representations that reflect intermediate reasoning states. These states are influenced by the training data and are shaped during inference through techniques such as masked self-attention, positional encoding, and next-token prediction, which collectively allow the LLM to simulate deductive or abductive reasoning processes. In some embodiments, explicit chain-of-thought prompting is used to guide the LLM in generating a sequence of intermediate natural language steps, enhancing the LLM’s ability to produce structured reasoning outputs. This capability enables the LLM to generate responses that are not merely retrieved facts but the result of multi-step inferential synthesis over the input data and the LLM’s internal knowledge representation.

### D. Agentic AI

Artificial intelligence (AI) agents as disclosed herein are software-implemented autonomous or semi-autonomous computational entities that can be configured to perceive, interpret, and act upon data (e.g., from other software and/or environmental input) to carry out tasks with minimal or no human intervention. The relationship between AI agents and LLMs may be hierarchical and/or functional. Thus, LLMs often serve as components within AI agents, enabling them to interpret language, generate responses, and make decisions based on textual inputs. In contrast, AI agents may be based on a framework that adds memory, goal management, action execution, and autonomy.

As an example implementation, each AI agent may comprise a modular architecture including, but not limited to, an input processing module, a perception engine, a decision engine, a planning and scheduling module, and an action execution layer. However, other implementations of AI agents are possible. Any of these modules may employ various forms of machine learning, including generative AI, to perform at least some of their functions.

The input processing module may receive diverse data types (e.g., structured messages, API calls, natural language commands, and telemetry streams) and convert them into standardized internal data representations. The perception engine may apply one or more machine learning models (e.g., transformer-based encoders, convolutional neural networks, or graph neural networks) to extract semantic features, detect anomalies, and classify incoming requests or events.

The decision engine may employ one or more reasoning techniques –including rule-based logic, probabilistic inference, chain of thought, and/or reinforcement learning – to select actions based on current system state and/or historical performance data. In certain embodiments, the decision engine may integrate policies (e.g., via a neural network trained via deep reinforcement learning) that enable the AI agent to adapt dynamically to changing workloads, network conditions, and resource availability. The planning and scheduling module can subsequently transform the chosen actions into executable workflows or API calls, taking into account dependencies, priorities, and/or real-time resource constraints. For example, an AI agent may schedule a series of microservice invocations across distributed computing nodes while aiming to satisfy latency and throughput targets.

The action execution layer may interface with external systems and service endpoints through standardized APIs or message buses (e.g., REST endpoints, remote procedure calls, message queues, or an event streaming platform). In some embodiments, agents may use a resource adapter that accesses cloud provider software development kits (SDKs) to provision virtual machines, allocate storage, or update network configurations. Telemetry and feedback loops can be established by monitoring execution outcomes and feeding performance data back into the perception engine and the decision engine, facilitating learning and self-reconfiguration.

Functionally, AI agents can be arranged to handle tasks such as intelligent request routing, error recovery, workload balancing, anomaly detection, and self-healing operations. For instance, in a distributed database system, an AI agent may detect a failing compute node through anomaly classification, reroute incoming queries to healthy replicas, and initiate automated failover procedures. In another example, an AI agent assigned to customer support automation parses natural language inquiries from end-users, classifies intents, retrieves relevant knowledgebase articles, makes recommendations, and/or composes a contextually appropriate response.

Example implementations include multi-agent systems in which multiple AI agents collaborate by publishing state updates to a shared knowledge graph or blackboard. Agents may negotiate task assignments using consensus algorithms or market-based mechanisms, thereby improving resource utilization across the network. Alternatively or additionally, AI agents could operate based on an agentic hierarchy (e.g., primary AI agents providing instructions to secondary AI agents) or otherwise direct the actions of other AI agents.

### VIII. Example Operational Environment

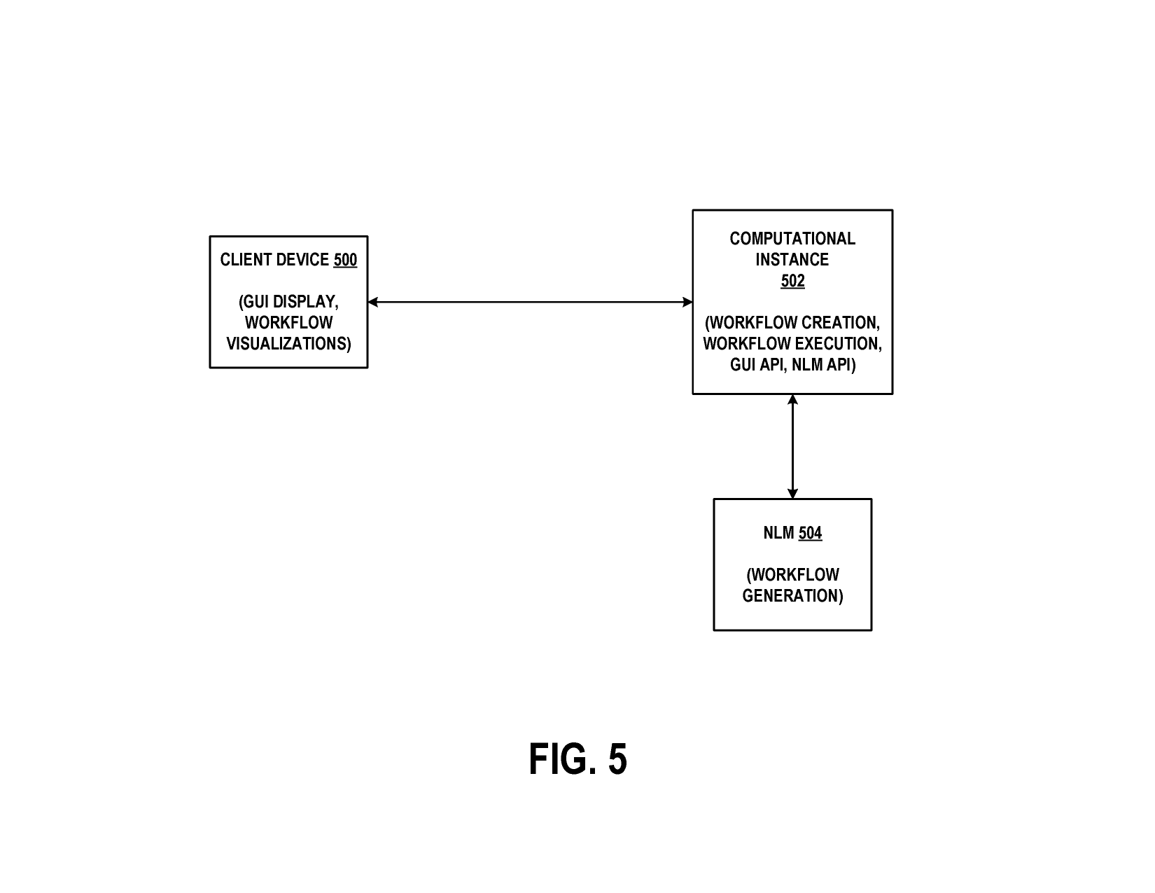

The embodiments described herein can operate on one or more computational instances of a remote network management platform, between one or more computational instances and a remotely-hosted (e.g., cloud-based) natural language model, or in other arrangements. An example logical architecture is shown in FIG. 5.

Client device 500 may be a desktop computer, laptop computer, or some other type of computing device arranged for interaction with a user by way of a GUI. The GUI may be displayed on one or more screens associated with client device 500. Further, the GUI may display workflow visualizations, allowing the user to participate in designing and/or executing at least part of a workflow.

Computational instance 502 may be a group of one or more compute and/or database nodes arranged to carry out the computational instance functions described herein. Computational instance 502 may facilitate, through its programming, workflow creation and workflow execution among other operations. Computational instance 502 may interact with client device 500 by way of a network (e.g., using a GUI API). Computational instance 502 may also interact with natural language model (NLM) 504 by way of a network (e.g., using an NLM API). Any functionality attributed to computational instance 322 of remote network management platform 320 may also be supported by computational instance 502.

NLM 504 may be any type of natural language model described herein, such as an LLM. NLM may be arranged to interface with other devices (e.g., computational instance 502 by way of a natural language interface (e.g., text-based prompts and responses). NLM 504, through its training, may be configured to generate workflows as described herein. NLM 504 may be integrated into computational instance 502, disposed within a different computational instance in the same data center or remote network management platform, or physically separate and remote from computational instance 502.

### IX. Example Workflows

As noted above, workflows can be automated or semi-automated multi-step processes that occur between any combination of computing systems components and/or users. A given computational instance can routinely use a large number of workflows for various purposes.

Workflows may be defined by way of remote network management platform 320 as state diagrams. Thus, each workflow may have a number of states and transitions therebetween. Certain automated actions may be performed in various states, such as setting values, executing a script, sending a notification, starting or stopping a timer, communicating with third-party remote servers, transitioning to a different state, and so on. Other actions may be triggered by state transitions. Some of these actions may involve waiting for user input, while others could be automated.

Additionally, each workflow may have one or more triggers that causes the workflow to initiate. These triggers can be based on any one or more of: user actions (e.g., a user requests the workflow to initiate), time and/or a schedule (e.g., a computing system is configured to initiate the workflow once per day), system monitoring exceptions (e.g., detection of an error on system operation or a parameter crossing a pre-defined threshold value), and/or other events (e.g., changes to a filesystem or a database, reception of a message, calling of an API function).

These workflows may be executed by a computational instance (e.g., computational instance 502). Thus, users may interact with workflows by way of one or more user interfaces of the computational instance. This may involve a user being notified by the computational instance (e.g., via email) that their input is needed for a particular work item that is in a particular state of a workflow. The user can then log on to the computational instance and enter the requested input through an appropriate user interface. In some cases, the user may also be able to view other parts of the workflow related to the work item, e.g., its values or actions from other states and/or a representation of its history.

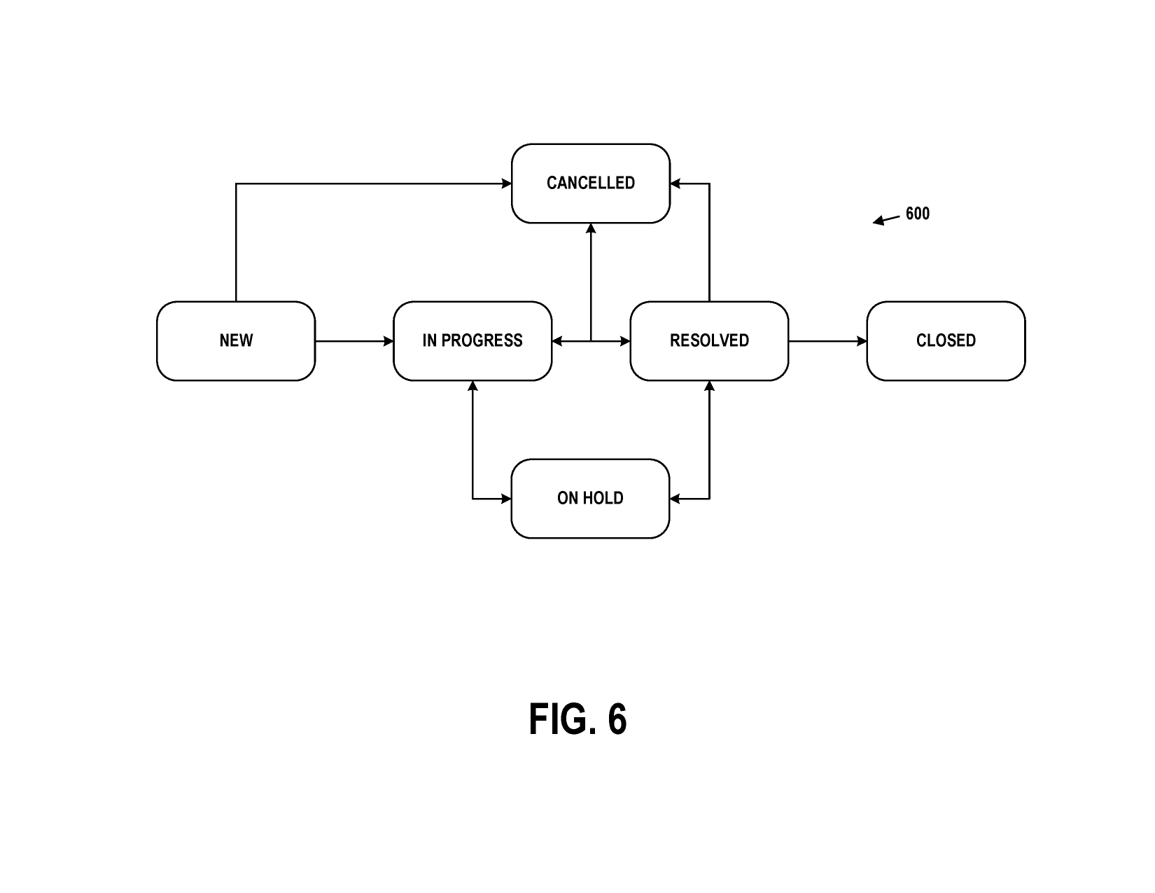

FIG. 6 depicts an example workflow 600, in which the boxes represent discrete states and the arrows between these states represent transitions. This workflow represents that of an IT incident. Such an incident may be created by a technology user who has encountered a problem (e.g., an application not working properly on their laptop, a network service that is not reachable) or automatically generated when an outage is detected. Each incident may progress through this workflow from the new state to either the cancelled state or the closed state. The incident may be assigned to an agent who is tasked with addressing the incident.

The states can be defined as follows. In the new state, the incident has been created but not yet investigated. In the in progress state, the incident has been assigned to an agent, and is being investigated or is scheduled for investigation. In the on hold state, the responsibility for the incident shifts temporarily from the assigned to another entity (e.g., the user or another agent) to provide further information, evidence, or a resolution. In the resolved state, the incident has been addressed by the agent. In the closed state, the incident has been confirmed to be satisfactorily resolved. In the cancelled state, the incident was triaged but found to be a duplicate incident, an unnecessary incident, or not representing an actual problem

Workflow 600 is just one possible incident management workflow. Other such workflows involving more or few states and/or transitions may be possible. Workflow 600 also serves to represent more complicated workflows that go beyond just incident management.

Data related to each work item that is processed by a workflow may be logged, saved, or otherwise stored by the computational instance hosting the workflow. For example, data related to the states and transitions used by each work item, how much time each work item stays in each state, the user or users associated with each work item, and so on may be written to one or more logs. These logs may exist as files in a filesystem, entries in a database, or in some other form.

Workflows can be presented on a GUI through a combination of visual and interactive GUI elements. These workflows may be displayed using flowchart-like diagrams where each step in the workflow is represented by distinct nodes or icons. These nodes are connected by lines or arrows indicating the sequence of operations and the flow of data or actions from one step to the next (for example, workflow 600 may be presented on a GUI largely as shown in FIG. 6). Each node may be labeled with a descriptive name and may include additional details or parameters that can be viewed or configured through pop-up windows or side panels.

Some workflows employ a step-by-step approach, presenting users with a series of interconnected pages (e.g., web pages) or screens that guide them through each stage of the workflow. Each page may focus on a specific task or set of related tasks. The GUI for such workflows often begins with a welcome or introductory screen that outlines the overall workflow and provides an overview of the steps involved. Navigation controls, such as “Next”, “Previous”, “Cancel”, and “Finish” buttons, may be displayed to allow movement forward and backward through the workflow or exit if necessary. Progress indicators, such as a step-by-step sidebar or breadcrumb trail, can be used to show the current position within the workflow and what steps remain.

Workflows may be implemented with program logic (e.g., scripts) that query specific fields of database tables for information relevant to the workflow and then provide this information along with further context for display by a GUI framework (e.g., a program or set of programs that produce a GUI from a programmatic specification thereof). In some cases, the database table names, field names, and GUI framework may be referenced indirectly by metadata. This allows a more flexible and implementation-independent interface between the program logic of the workflow and different types of databases and GUI frameworks.

### X. Using Natural Language to Generate Workflows

Natural language processing (NLP) systems, such as LLMs, can be used to generate high-level outlines of workflows from natural language descriptions thereof. However, until now these models have been unable to generate a complete workflow from natural language due to the difficulty of defining the individual steps and specifying step inputs.

Many workflows have numerous steps, and each step may involve different inputs. Some step inputs may come from values stored in a specific field of a database table, from user input (e.g., received by way of a GUI), or from the output of a previous step of the workflow. As noted, each of these inputs may be associated with specific metadata. In many cases, this metadata is not known to an LLM. But even if the LLM is fine-tuned on this metadata and its relationships to various input sources (e.g., database tables and fields, GUI-based input, and/or workflow output), LLMs are often unable to generate accurate full workflows with all steps populated based on an overall natural language description for the workflow. Moreover, LLMs are known to hallucinate, thereby providing incorrect or misleading outputs when not given sufficiently specific prompts. LLMs are particularly prone to hallucination when asked to produce a complicated output from a relatively simple or vague prompt.

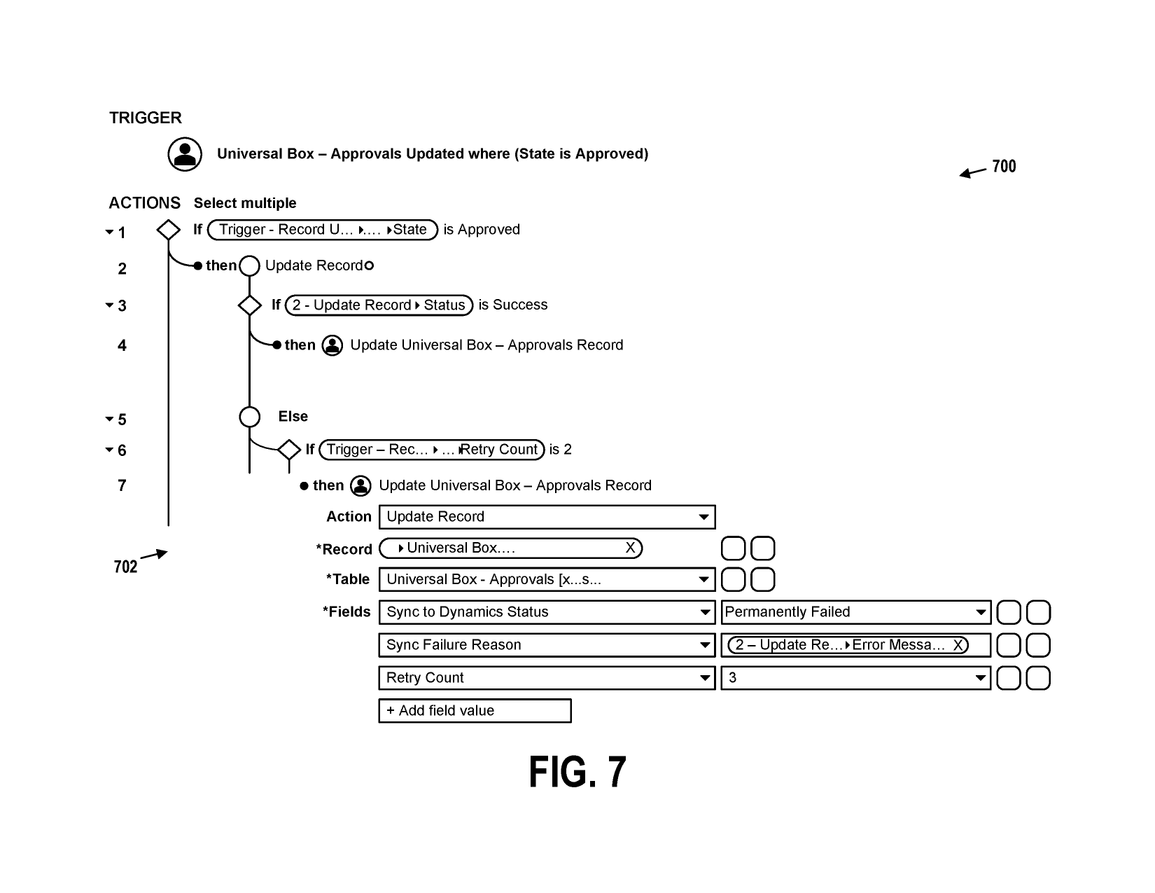

FIG. 7 provides an example by way of GUI 700 for defining and configuring an automated workflow 702 in accordance with embodiments described herein. GUI 700 allows a user to visually specify trigger conditions, conditional branches, and corresponding actions for execution within workflow 702. In the example shown, workflow 702 operates on records of a data object referred to as Universal Box Approvals.

At step 1, Workflow 702 is triggered when such a record is subject to an update, where the update changes the state field of the record to approved. At steps 2-7 and in response to triggering, workflow 702 proceeds to execute the update. At step 3 and as part of this action, workflow 702 evaluates whether the update was successful by checking the status field returned by the update action. If the update succeeded, then at step 4 workflow 702 exits indicating success. If the update failed, then at steps 5-7 remediating actions are taken. At step 6, workflow 702 evaluates whether a retry count associated with the record equals 2. If this retry condition is satisfied, then at step 7 workflow 702 executes an action that updates the record to indicate a permanent failure by setting the values of various fields.

Specifically, step 7 of workflow 702 updates the fields in the database table “Universal Box – Approvals”. It updates three fields, “Sync to Dynamic Status”, “Sync Failure Reason” and “Retry Count”, each to different values. The first value comes from a list of choices, the second value comes from the output of a previous step (in this case, step 2), and the third value is a scalar. Populating the inputs of each step requires knowledge specific to a computing system, e.g., its database schema and/or application or system configuration, which is outside of what is usually used to train a general LLM.

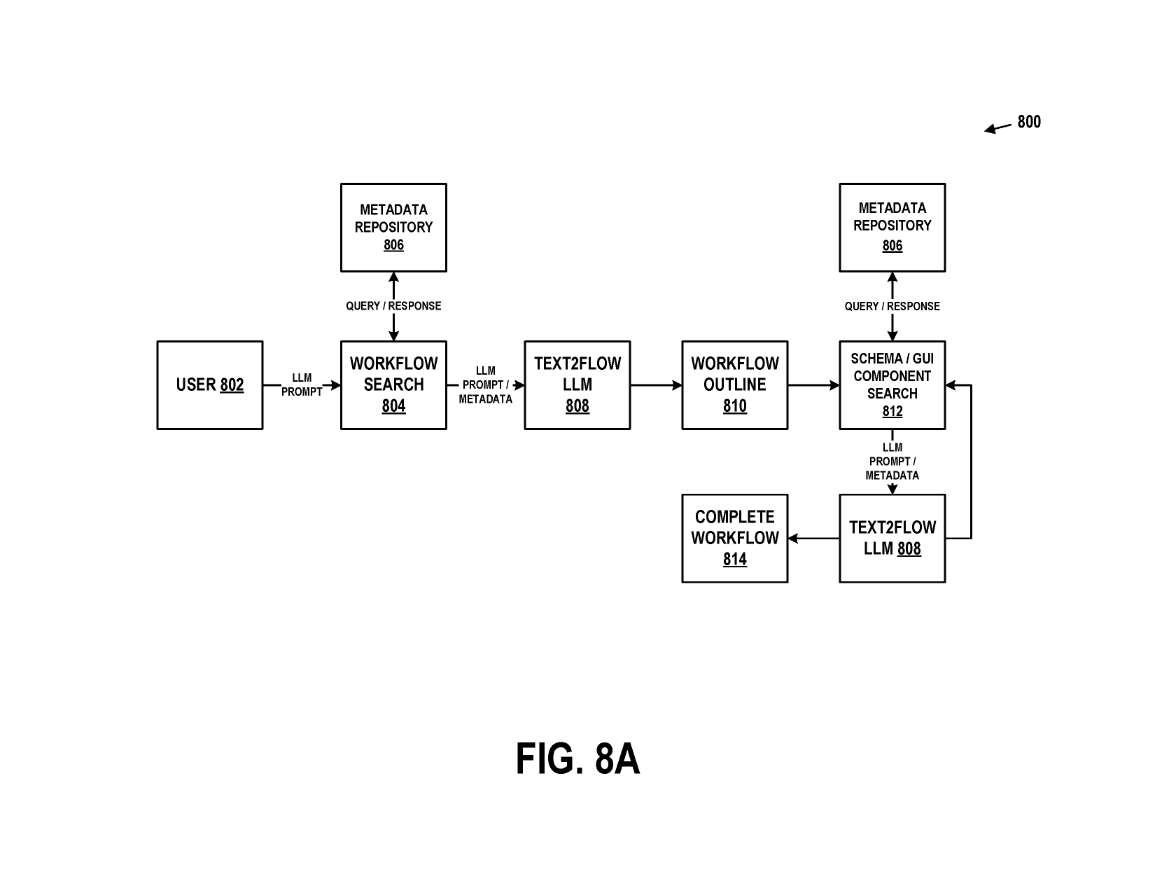

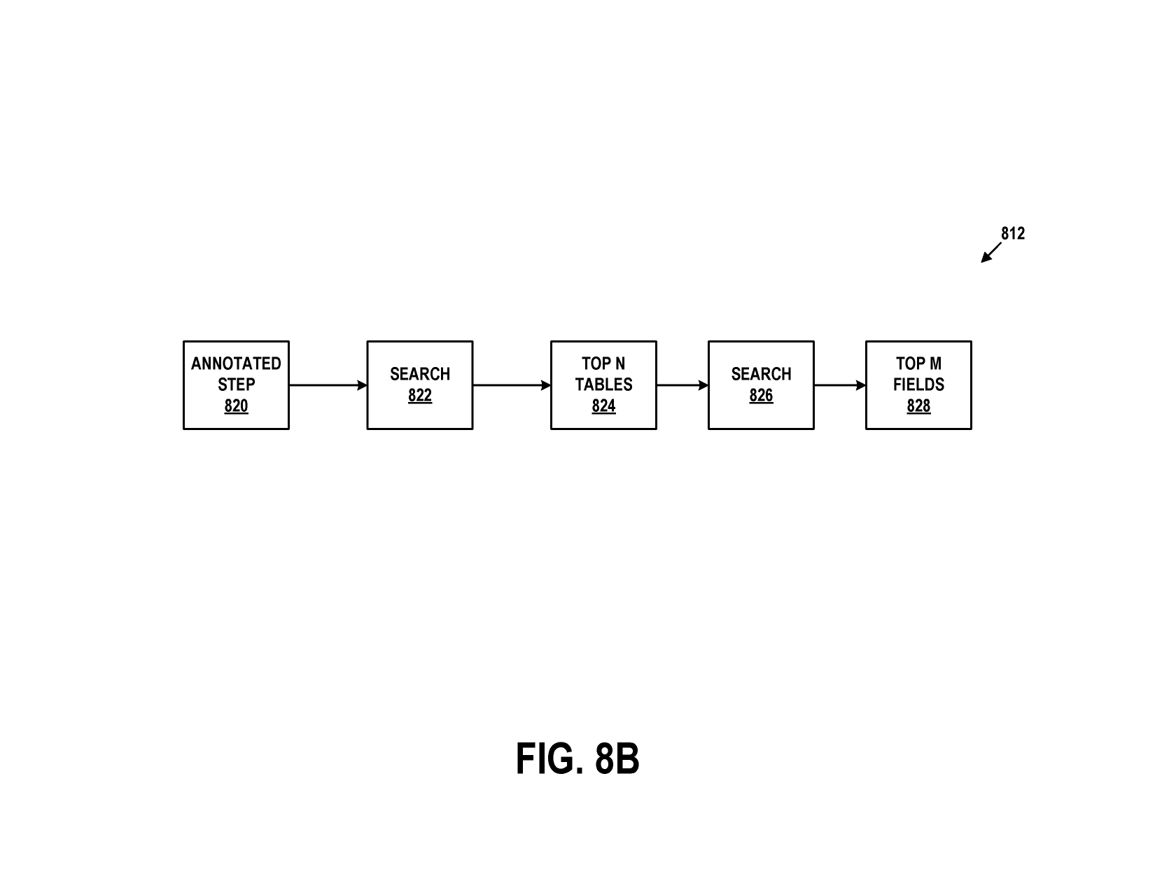

FIG. 8A provides a process 800 for using an LLM to generate specifications of workflows. Unlike prior attempts to do so, process 800 employs a multiphase approach that reduces computational load and resource utilization, reduces hallucinations, and provides superior results. Notably, process 800 divides workflow generation into two distinct phases. First, an outline of the workflow is generated, which defines a sequence of steps of the workflow. Then, a definition of each step is generated.

In some embodiments, the LLM (referred to as “Text2Flow LLM” in FIG. 8A) may have been trained or fine-tuned on metadata relating to the computational instance for which it is generating the workflow. This metadata may include a representation of one or more database schema, GUI designs or frameworks, other workflows, and so on.

Both phases may use metadata to enhance or accompany the prompts provided to the LLM. Enhancing the prompts with metadata may involve receiving a prompt from a user and modifying the prompt to incorporate some aspect of the metadata. Accompanying the prompts with metadata may involve providing metadata with the prompts as reference material. In either case, the LLM may use both the prompt and the metadata to produce its output.

Referring to FIG. 8A, user 802 may obtain, write, edit, and/or provide an LLM prompt that describes the workflow that is to be generated. This prompt may be textual and in the form of natural language.

Block 804 may involve the computational instance initiating a search to identify metadata from metadata repository 806 that possibly relates to the text of the prompt. This may involve identifying steps of other workflows that performed similar tasks. Doing so may involve querying metadata repository 806 based on the prompt, and metadata repository 806 identifying and returning the associated metadata in a corresponding response. Metadata repository 806 may take the form of various types of computer storage, e.g., a filesystem, database, etc.

The identification of metadata from the metadata repository 806 that relates to the text of the prompt may employ various similarity techniques to improve the relevance and accuracy of the search results. For example, the metadata repository 806 may apply NLP techniques to compute semantic similarity between the prompt and textual descriptions associated with metadata entries, such as workflow step names, descriptions, or associated annotations. Vector-based similarity methods (e.g., cosine similarity of embeddings generated using transformer models or other language models) may be utilized to identify metadata entries corresponding to workflow steps that perform tasks semantically related to those described in the prompt. Additionally, keyword matching, fuzzy string matching, or pattern recognition techniques may be employed to detect partial or approximate matches between terms in the prompt and metadata records.

The prompt and the metadata (either enhancing or accompanying the prompt) may be provided to LLM 808. In response, LLM 808 initially generates workflow outline 810 for the workflow, e.g., identifying each of the steps of the workflow (for sake of simplicity, the trigger of the workflow may be one of these steps).

In some cases, such as when a workflow does not require customized (e.g., user-defined) metadata, the metadata provided by metadata repository 806 for generation of workflow outline 810 may be ignored. For example, there may be a core set of workflow steps that the LLM memorizes during training and can then produce reliably during inference.

Regardless, each step of workflow outline 810 may be annotated (e.g., tagged) with an additional metadata element that is derived from the prompt and identifies a discrete action for the step. In some cases, a representation of workflow outline 810 may be displayed to a user as an intermediate result.

Block 812 may involve the computational instance initiating a search to identify metadata (e.g., representations of one or more database schema and/or GUI components) from metadata repository 806 that possibly relates to a particular step of the workflow. Doing so may involve querying metadata repository 806 based on a particular step of workflow outline 810, and metadata repository 806 identifying and returning the associated step-specific metadata. In some cases, metadata repository 806 may be split into two logical or physical repositories, one for identifying similar workflow steps and another for identifying database schema and/or GUI components. Again, NLP-based similarity techniques may be employed to identify the metadata.

A representation of the particular step of the workflow and this step-specific metadata may be provided to LLM 808. In response, LLM 808 generates a specification of the step of the workflow. This specification may be combined into workflow outline 810 (e.g., enhancing or replacing the representation of the step in workflow outline 810). In some cases, representations of one or more previous and/or subsequent steps of the workflow may be provided to LLM 808 for context. Block 812 may iterate through the steps of workflow outline 810 one by one (e.g., in order from the first step to the last) until specifications of all steps may have been generated and incorporated into workflow outline 810.

Complete workflow 814 represents the output of process 800. It may take the form of workflow outline 810 filled out with the specification of its steps as generated during the iterations of block 812.

FIG. 8B depicts the operations of block 812 in more detail. In particular, an annotated step 820 of workflow outline 810 is searched 822 within metadata repository 806 to identify the top N database tables 824 that are likely to be related. Here, a similarity-based textual search may be used and N may be any number from 1 to 10 for example. Then, the fields of database tables 824 are searched to identify the relevant fields therein. This may be a large number of fields (tens or hundreds), and not all are guaranteed to be relevant to the step. Therefore, these fields are searched 826 within metadata repository 806 to identify the top M fields 828 most relevant to annotated step 820. Again, a similarity-based textual search may be used and M may be any number from 1 to 10 for example. In sum, N tables and/or M table fields (along with their possible values if they are list of choices) are provided to the LLM.

By performing a similarity-based search to identify the top N database tables likely to be related to a workflow step, and further narrowing to the top M most relevant fields within those tables, the system effectively constrains the inputs provided to the LLM. Rather than requiring the LLM to process or reason over the entire set of available tables and fields (which may number in the hundreds or more) the LLM is presented with a curated subset of contextually relevant database objects. This reduction in input scope decreases the volume of data the LLM analyzes, leading to fewer processor cycles, lower memory consumption, and faster response times. Moreover, by pre-filtering inputs in this manner, the system reduces noise in the LLM’s input, which can improve the accuracy and relevance of the generated workflow outputs. The narrowing of search space through this multi-stage similarity-based filtering represents a technical improvement over approaches that provide the LLM with unfiltered or minimally filtered data.

FIGS. 8A and 8B represent one possible technique for generating a specification of a workflow. Variations of this technique are possible without deviating from the scope of the embodiments herein. Notably, non-database operations are possible.

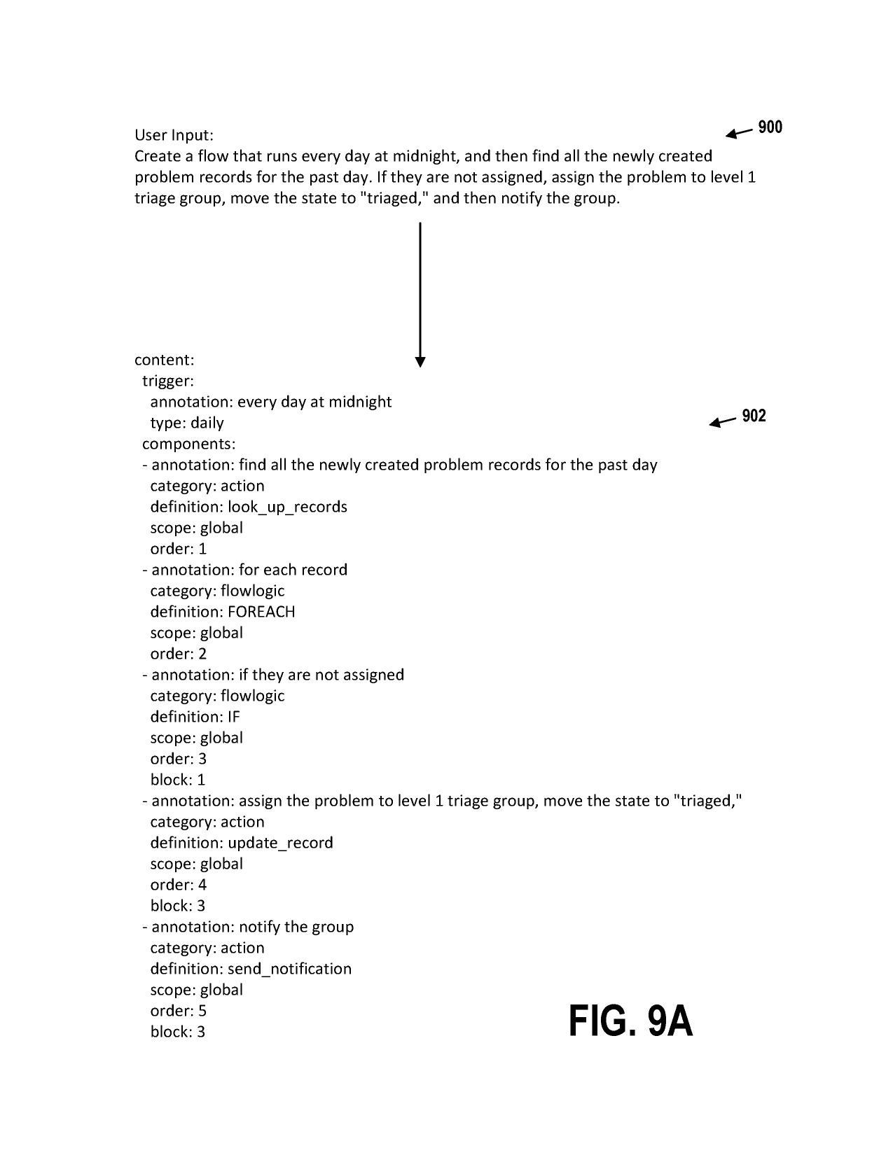

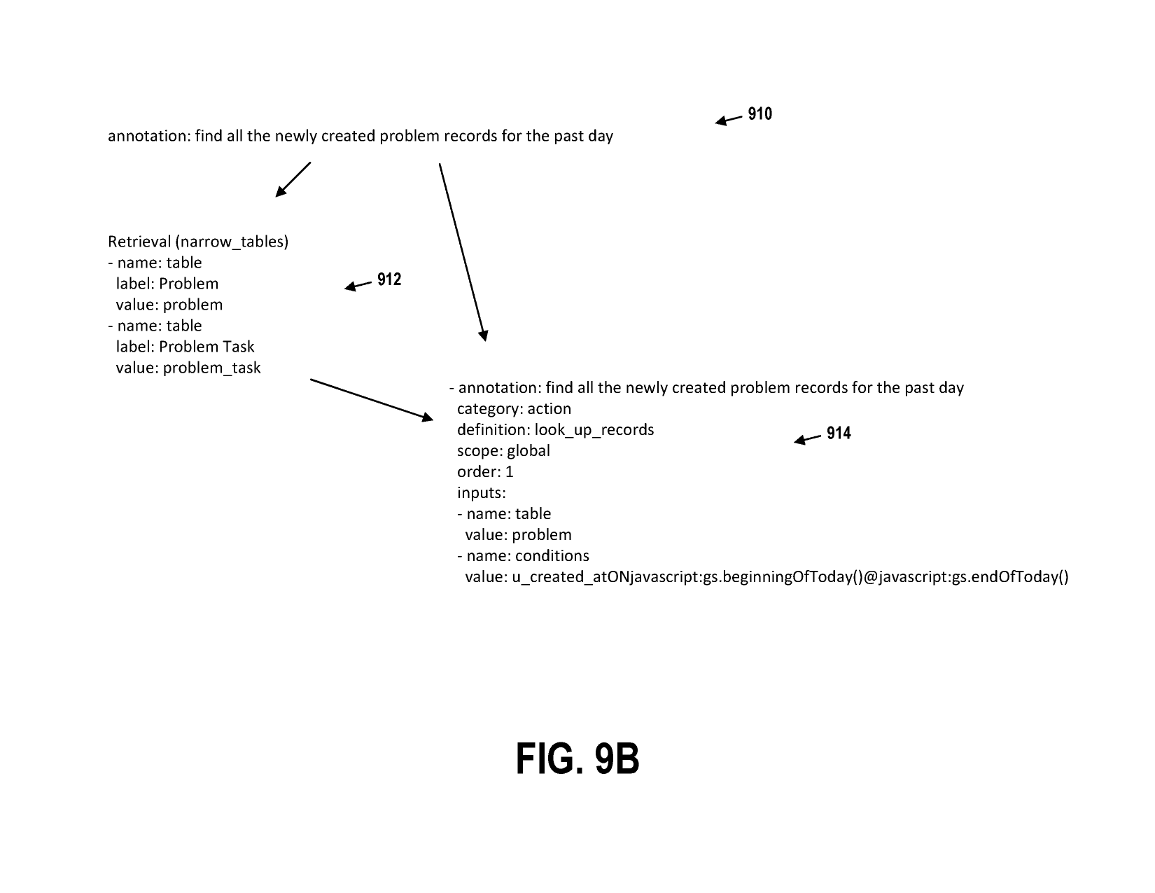

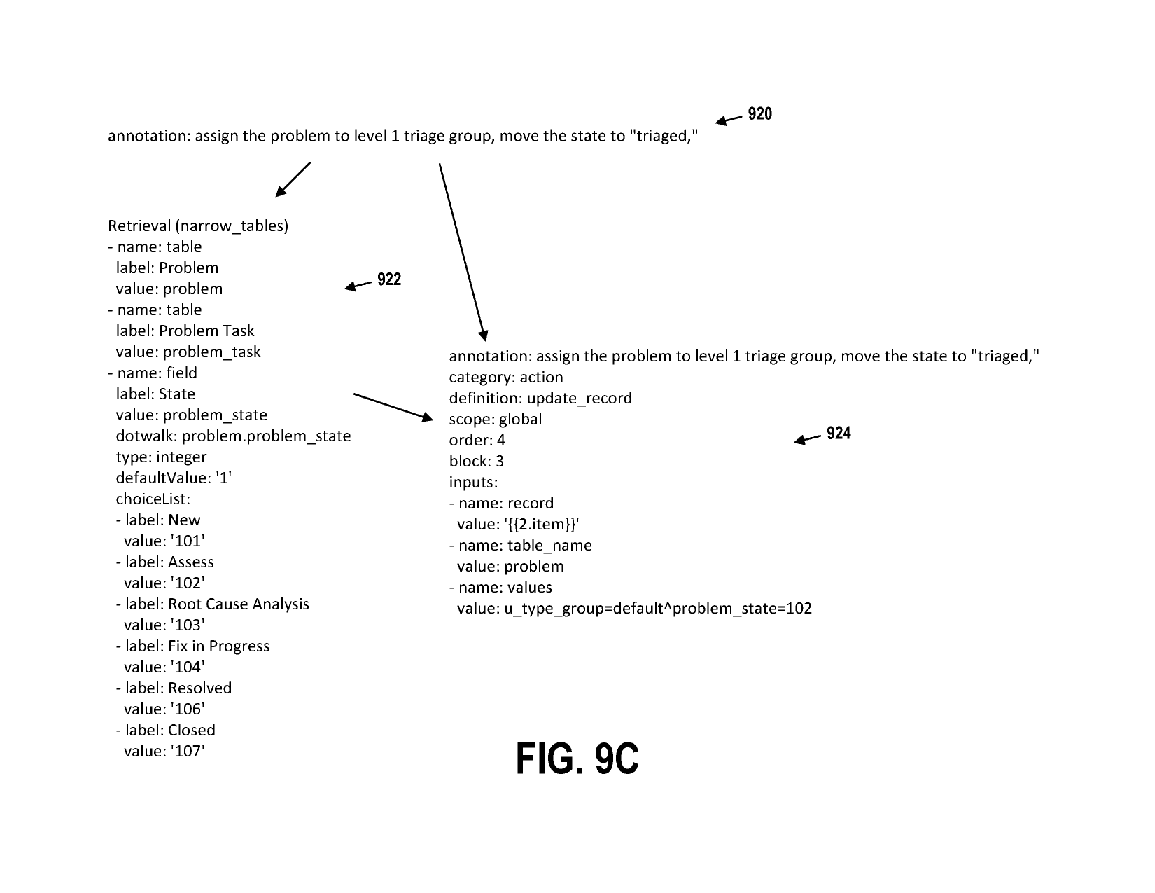

FIG. 9A depicts an example of generating a workflow outline from a prompt. In particular, a user may input prompt 900, which specifies a workflow in natural language, to an LLM with possible additional metadata. Here, prompt 900 is “Create a flow that runs every day at midnight, and then find all the newly created problem records for the past day. If they are not assigned, assign the problem to level 1 triage group, move the state to ‘triaged,’ and then notify the group.” In this case, the workflow does not require customized metadata and thus the LLM may ignore any metadata returned from the metadata repository. Therefore, this metadata is not shown.

Next, the LLM may produce workflow outline 902. Notably, workflow outline 902 identifies the workflow’s trigger (annotated as “every day at midnight”), and steps as a series of components. For example, the first step (annotated as “find all the newly created problem records for the past day”) has been defined as an action that involves looking up records in a database (as indicated by the look_up_records tag). Likewise, the fourth step (annotated as “assign the problem to level 1 triage group, move the state to ‘triaged,’”) has been defined as an action that involves updating a record in a database (as indicated by the update_record tag).

FIG. 9B depicts an example of generating a specification of a step of the workflow, particularly the first step. Accordingly, the annotation 910 (“find all the newly created problem records for the past day”) is used to query the metadata repository to identify potentially relevant database tables and/or fields. Here, only database tables can be identified, particularly the problem and problem_task database tables as represented in metadata 912. Then, annotation 910 and/or metadata 912 may be provided to the LLM to generate further tags for the step of the workflow. The revised step 914 includes a specific table (problem) and search conditions used to look up records in this table so that only records created on the current day are returned.

FIG. 9C depicts an example of generating a specification of a step of the workflow, particularly the fourth step. Accordingly, the annotation 920 (“assign the problem to level 1 triage group, move the state to ‘triaged,’”) is used to query the metadata repository to identify potentially relevant database tables and/or fields. Here, both database tables and fields can be identified, particularly the problem and problem_task database tables, and the problem_state field of the problem database table, as represented in metadata 922. Metadata 922 also includes a list (specified by the “choiceList” tag) of possible values for the problem_state field. Then, annotation 920 and/or metadata 922 may be provided to the LLM to generate further tags for the step of the workflow. The revised step 924 includes a specific table (problem) and a value (“102”) that maps to assessment of the problem. This was determined by the LLM to be the closest match to a “triaged” state.

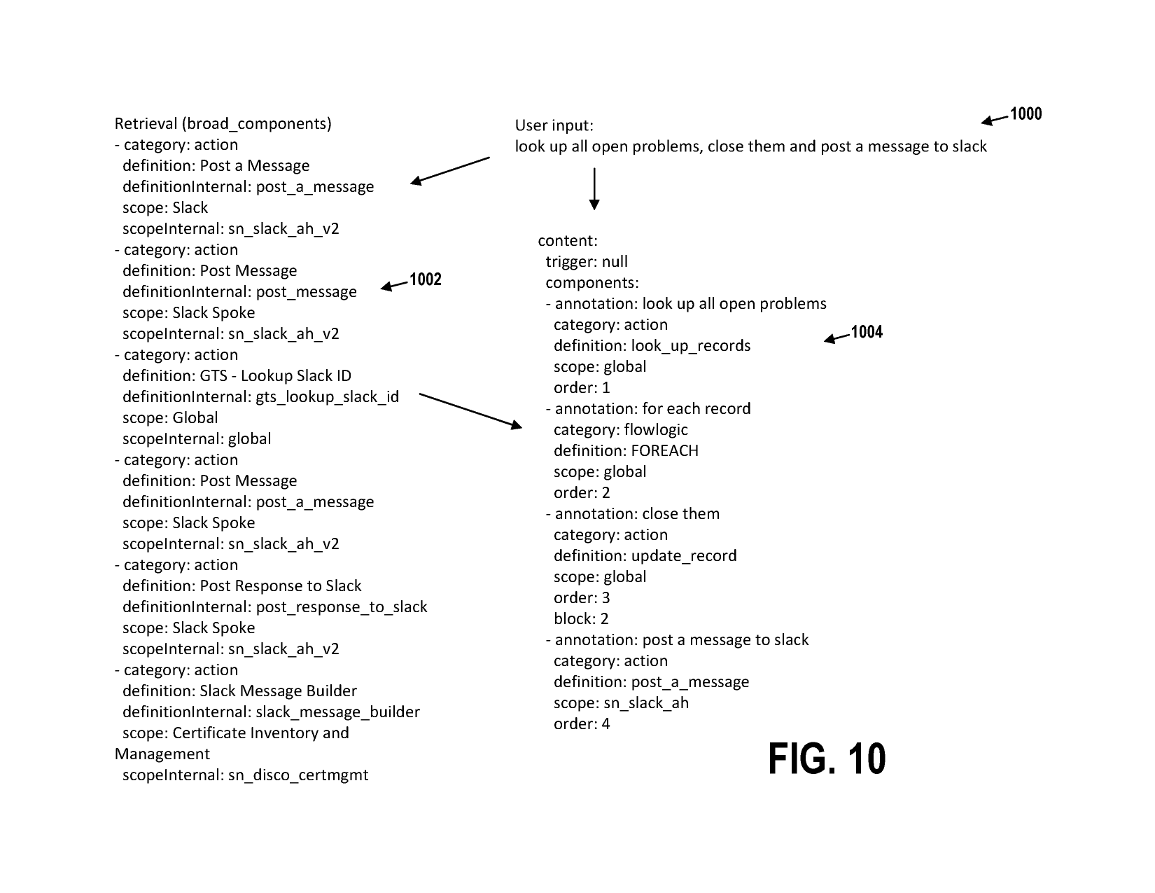

To further illustrate the embodiments herein, FIG. 10 depicts generating a workflow outline from prompt 1000. Unlike workflow outline 902, this workflow outline involves customized metadata (e.g., specialized steps). Thus, the metadata repository is queried with prompt 1000 and responsively provides metadata 1002. This metadata defines a programmatic interface to a messaging service. Then, prompt 1000 and/or metadata 1002 may be provided to the LLM. The LLM may generate workflow outline 1004 in response.

### XI. Example Operations

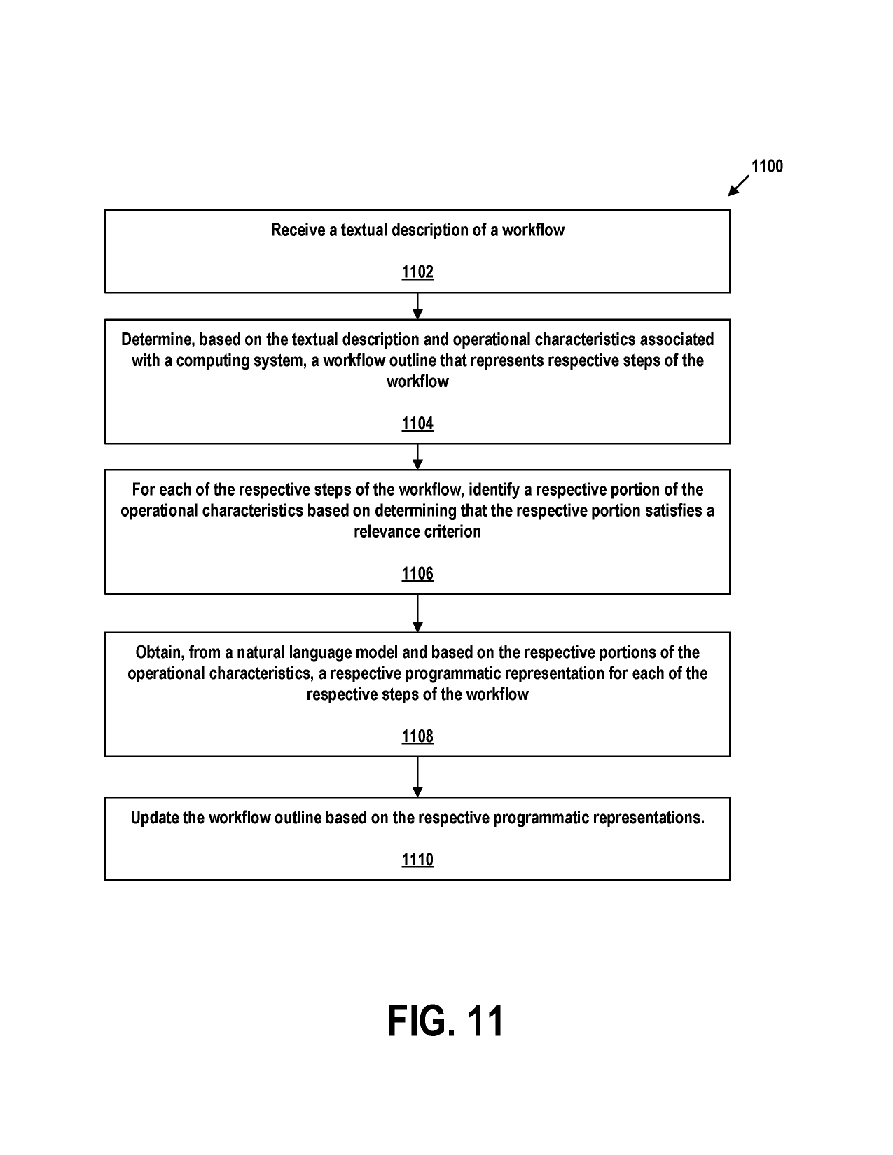

FIG. 11 is a flow chart 1100 illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1102 may involve receiving a textual description of a workflow. Block 1104 may involve determining, based on the textual description and operational characteristics associated with a computing system, a workflow outline that represents respective steps of the workflow. Block 1106 may involve, for each of the respective steps of the workflow, identifying a respective portion of the operational characteristics based on determining that the respective portion satisfies a relevance criterion. Block 1108 may involve obtaining, from a natural language model and based on the respective portions of the operational characteristics, a respective programmatic representation for each of the respective steps of the workflow. Block 1110 may involve updating the workflow outline based on the respective programmatic representations.

The steps described provide several technical improvements that address inefficiencies and inaccuracies associated with conventional workflow generation methods. First, receiving a textual description of a workflow (block 1102) and determining a workflow outline based on that description and the operational characteristics of a computing system (block 1104) improves over ad hoc workflows by making it so that the generated outline is tailored to the specific capabilities, constraints, and configurations of the target system. This results in workflows that are better aligned with the execution environment, reducing the likelihood of runtime errors or computational resource wastage.

Identifying portions of the operational characteristics that satisfy a relevance criterion for each step (block 1106) further narrows the information considered in subsequent processing. This reduces the search space and input complexity for the natural language model, leading to more efficient processing, lower processor and memory capacity consumption, and faster generation of programmatic representations. It also mitigates the risk of including extraneous or irrelevant system details that could degrade workflow accuracy or introduce unnecessary complexity.

In some embodiments, each of the respective steps of the workflow includes a respective annotation.

In some embodiments, identifying the respective portion of the operational characteristics comprises determining, based on the respective annotation, the respective portion of the operational characteristics that is relevant to the respective step.

In some embodiments, wherein obtaining the respective programmatic representation for each of the respective steps of the workflow comprises providing, to the natural language model, the respective annotation and the respective portions of the operational characteristics.

In some embodiments, determining that the respective portion satisfies the relevance criterion comprises determining that the respective portion satisfies the relevance criterion with respect to the corresponding step of the workflow.

In some embodiments, the operational characteristics are expressed as metadata.

In some embodiments, the operational characteristics comprise a database schema usable by the computing system.

In some embodiments, the operational characteristics relate to an application executable by the computing system.

In some embodiments, determining the workflow outline that represents the respective steps of the workflow comprises: based on the textual description, determining the operational characteristics; providing, to the natural language model, the textual description and the operational characteristics; and receiving, from the natural language model, the workflow outline.

In some embodiments, the workflow outline comprises a textual definition of the workflow.

In some embodiments, the workflow is configured to be initiated in response to a triggering event, the method further comprising: deploying the workflow on the computing system; detecting the triggering event; and based on the triggering event, causing the workflow to execute.

In some embodiments, execution of the workflow causes one or more of: updating an entry in a database associated with the computing system, allocating or deallocating computational resources, transmission of a message, generating a log entry, changing configuration or state on a computing device, or updating security parameters of the computing device.

These features provide a technical solution to the technical problem of generating and deploying efficient and reliable workflows. Specifically, the deployment and execution of a workflow in response to a detected triggering event results in actual modifications to a computing system’s or device’s data structures, resource allocation, and/or operational state. For example, execution of the workflow updates entries in a database, allocates or deallocates computational resources, transmits messages to external systems or components, generates log entries, alters configuration parameters or device state, and/or updates security settings. These operations constitute specific, technical actions that modify how a computer functions at a fundamental level. This involves the dynamic management of system resources, automated modification of system configuration, and structured updates to security and operational data, all of which improve the functioning of the computer system itself.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a textual description of a workflow;
determining, based on the textual description and operational characteristics associated with a computing system, a workflow outline that represents respective steps of the workflow;
for each of the respective steps of the workflow, identifying a respective portion of the operational characteristics based on determining that the respective portion satisfies a relevance criterion;
obtaining, from a natural language model and based on the respective portions of the operational characteristics, a respective programmatic representation for each of the respective steps of the workflow; and
updating the workflow outline based on the respective programmatic representations.

2. The method of claim 1, wherein each of the respective steps of the workflow including a respective annotation.

3. The method of claim 2, wherein identifying the respective portion of the operational characteristics comprises determining, based on the respective annotation, the respective portion of the operational characteristics that is relevant to the respective step.

4. The method of claim 3, wherein obtaining the respective programmatic representation for each of the respective steps of the workflow comprises:
providing, to the natural language model, the respective annotation and the respective portions of the operational characteristics.

5. The method of claim 1, wherein determining that the respective portion satisfies the relevance criterion comprises determining that the respective portion satisfies the relevance criterion with respect to the corresponding step of the workflow.

6. The method of claim 1, wherein the operational characteristics are expressed as metadata.

7. The method of claim 1, wherein the operational characteristics comprise a database schema usable by the computing system.

8. The method of claim 1, wherein the operational characteristics relate to an application executable by the computing system.

9. The method of claim 1, wherein determining the workflow outline that represents the respective steps of the workflow comprises:
based on the textual description, determining the operational characteristics;
providing, to the natural language model, the textual description and the operational characteristics; and
receiving, from the natural language model, the workflow outline.

10. The method of claim 1, wherein the workflow outline comprises a textual definition of the workflow.

11. The method of claim 1, wherein the workflow is configured to be initiated in response to a triggering event, the method further comprising:
deploying the workflow on the computing system;
detecting the triggering event; and
based on the triggering event, causing the workflow to execute.

12. The method of claim 11, wherein execution of the workflow causes one or more of: updating an entry in a database associated with the computing system, allocating or deallocating computational resources, transmission of a message, generating a log entry, changing configuration or state on a computing device, or updating security parameters of the computing device.

13. A non-transitory computer-readable medium, having stored thereon program instructions that, upon execution by a computing system, cause the computing system to perform operations comprising:
receiving a textual description of a workflow;
determining, based on the textual description and operational characteristics associated with the computing system, a workflow outline that represents respective steps of the workflow;
for each of the respective steps of the workflow, identifying a respective portion of the operational characteristics based on determining that the respective portion satisfies a relevance criterion;
obtaining, from a natural language model and based on the respective portions of the operational characteristics, a respective programmatic representation for each of the respective steps of the workflow; and
updating the workflow outline based on the respective programmatic representations.

14. The non-transitory computer-readable medium of claim 13, wherein each of the respective steps of the workflow including a respective annotation.

15. The non-transitory computer-readable medium of claim 14, wherein identifying the respective portion of the operational characteristics comprises determining, based on the respective annotation, the respective portion of the operational characteristics that is relevant to the respective step.

16. The non-transitory computer-readable medium of claim 15, wherein obtaining the respective programmatic representation for each of the respective steps of the workflow comprises:
providing, to the natural language model, the respective annotation and the respective portions of the operational characteristics.

17. The non-transitory computer-readable medium of claim 13, wherein determining that the respective portion satisfies the relevance criterion comprises determining that the respective portion satisfies the relevance criterion with respect to the corresponding step of the workflow.

18. The non-transitory computer-readable medium of claim 13, wherein the operational characteristics comprise a database schema usable by the computing system or relate to an application executable by the computing system.

19. The non-transitory computer-readable medium of claim 13, wherein determining the workflow outline that represents the respective steps of the workflow comprises:
based on the textual description, determining the operational characteristics;
providing, to the natural language model, the textual description and the operational characteristics; and
receiving, from the natural language model, the workflow outline.

20. A system comprising:
one or more processors; and
memory, containing program instructions that, upon execution by the one or more processors, cause the system to perform operations comprising:
receiving a textual description of a workflow;
determining, based on the textual description and operational characteristics associated with a computing system, a workflow outline that represents respective steps of the workflow;
for each of the respective steps of the workflow, identifying a respective portion of the operational characteristics based on determining that the respective portion satisfies a relevance criterion;
obtaining, from a natural language model and based on the respective portions of the operational characteristics, a respective programmatic representation for each of the respective steps of the workflow; and
updating the workflow outline based on the respective programmatic representations.
